(19) United States
(12) Patent Application Publication
(10) Pub. No.: US 2014/0115451 A1
(43) Pub. Date: Apr. 24, 2014

(54) SYSTEM AND METHOD FOR GENERATING HIGHLY CUSTOMIZED BOOKS, MOVIES, AND OTHER PRODUCTS

(71) Applicant: Madeleine Brett Sheldon-Dante, Penn Valley, PA (US)

(72) Inventor: Madeleine Brett Sheldon-Dante, Penn Valley, PA (US)

(21) Appl. No.: 13/929,919

(22) Filed: Jun. 28, 2013

Related U.S. Application Data
(60) Provisional application No. 61/665,383, filed on Jun. 28, 2012.

(51) Int. Cl. G06F 17/24

(52) U.S. Cl. CPC G06F 17/24
USPC 715/255

(57) ABSTRACT

A system and method is described for customizing commercial-quality movies, books, and other products and media. An interface is employed to guide customers through the customization process, presenting a menu of available movies, books, products, and other offerings, as well as providing customers with the ability to continuously or discretely adjust a wide range of physical attributes to improve resemblance between them and their characters. A high degree of customization is achieved through the selective adjustment of the transparency of two-dimensional layers, through the manipulation of three-dimensional models, or through a combination thereof. Files size is kept to a minimum by recursively adding categories of body components to a base file. A dynamic database of body components is structured for easy expansion and so as to allow characters to migrate easily between artistic styles.

### CROSS-REFERENCE TO RELATED APPLICATIONS

This application claims the benefit of U.S. Provisional Application No. 61/665,383 filed Jun. 28, 2012, the disclosure of which is incorporated herein by reference.

### TECHNICAL FIELD

Embodiments of the present invention generally relate to books, movies, episodic animated shows, and other printed and digital media. The invention more particularly relates to user-customized books, movies, episodic animated shows, and other printed and digital media, especially those intended for children.

### BACKGROUND OF THE INVENTION

Custom books have been available by mail-order for many decades, and have been especially popular as gifts for children. The purchaser, usually a parent, could specify the child's name, city of origin, the names of friends, and even favorite foods and hobbies, and these details would be incorporated into a custom book, in which the child starred as the main character. These books were typically produced using a variable printing press, which would take in a spreadsheet of data from all the customers, and print each customer's data into places left blank in the book.

Due to the practical and technological limitations of this method, only the text of the book was customizable, and even that only to a very limited extent. The illustrations were fixed, and the disparity between the child's appearance and the main character's appearance in the book was addressed through clever plot tricks, such as having the main character only shown in illustrations wearing a disguise or Halloween costume.

Use of the variable printing press was necessitated by the prohibitively high expense of printing single books with traditional offset printing, a process which is only economical when printing large runs of identical books. Today, improvements in the variable printing press and advances in digital printing have made it economically feasible to print runs of a single book at a time. However, a considerable obstacle still remains to the production of truly customized books and other media publications: a flexible, scalable, safe, and automated methodology for creating commercial-quality, customized visuals in traditional and digital artistic media. This obstacle is addressed by the present invention.

A significant social need exists for polished, professional-quality media publications that are also highly-customizable. One shortcoming of the entertainment industry is that books and other media publications are targeted towards the most marketable demographics, and as a result many children never see mainstream book or movie characters that look like them. The present invention allows every child to see themselves and their family reflected in stories and other media publications. For instance, with the present invention, children with physical disabilities, children who are adopted, children raised by grandparents, children with parents of two different races, and children with a parent away in the military are all able to create characters that match their unique family structure. Providing children with characters they can related to is important for building self-esteem, managing anxiety and grief, and encouraging reading skills.

Various systems and methods for creating customizing output have been proposed, for example U.S. Pat. No. 2008/0189609 to Larson, U.S. Pat. No. 8,112,029, to Marroquin, U.S. Pat. No. 6,694,482 to Arellano, U.S. Pub. No. 2002/0124048 to Zhou, and U.S. Pub. No. 2002/0077848 to Campbell. Though these disclosures relate to creating customized books or other media, they all lack the ability to combine non-variable, vendor-established elements with variable elements disposed to be customized by the user, an ability which is critical for creating commercial-quality customizable media. Furthermore, the above disclosures have little or no means of customizing the appearance of characters and illustrations.

U.S. Pat. No. 2007/0256011 to Jones makes progress in addressing these issues, however, this disclosure does not allow for the creation of e-books, movies, and many other forms of publishable media. Moreover, it is not flexible enough to allow customizable components to be originally created in two-dimensional artistic media. This greatly limits the possible styles for the finished illustrations, making, for instance, the production of a traditional children's book with flat watercolor or ink illustrations impossible.

Furthermore, none of the above systems and methods teach or suggest the selected use via variable transparency of flat artist-prepared drawings either directly or in combination with 3D wire-frames to produce customized pictures combining the personal with images of artistic merit.

Therefore, it is an object of the present invention to provide a system and method to customize characters and objects through varying the transparency of component layers originally created in a two-dimensional medium, as well as through varying the transparency of said two-dimensional component layers in combination with manipulating three-dimensional components. Accordingly, the present invention offers a greater degree of customization than previously existing systems and methods. These embodiments also offer the considerable technical advantage of allowing the vendor to produce customizable illustrations in traditional artistic media such as watercolor, ink, and colored pencil as well as in digital media.

It is a further object of the present invention to provide a system and method of customizing characters, objects, and text that is flexible enough to allow for the user to change the number of customizable characters in a given instance of published media. This has important applications for grief management, where, for instance, a child experiencing a divorce or the death of a parent might find it particularly painful to read bedtime stories depicting both parents.

Many exigent technologies for customizing output require a child to be photographed, which could have the negative safety consequence of establishing a database of children's photographs, names, and shipping addresses. Therefore, it is a further object of the present invention to provide a system and method of customizing characters and objects that does not employ photographs of children.

It is a further object of the present invention to provide a system and method of customizing movies, episodic shows, and other moving media using wire frame or other three-dimensional characters and objects, or two-dimensional characters and objects, or some combination of the two.

It is a further object of the present invention to provide a system and method in which the user can specify the poses and locations of the characters and objects.

It is a further object of the present invention to provide a system and method for building a dynamic database of visual components, which may have the technical advantage of allowing character and object components to be added at any time to meet the needs of users, as well as allowing characters to switch easily between artistic styles.

It is a further object of the present invention to provide a system and method for recursively combining categories of visual components, which may have the technical advantage of keeping file sizes small.

### BRIEF DESCRIPTION OF THE INVENTION

According to one embodiment of the invention, the customer accesses a customization interface, creates a profile, and browses available offerings. Examples of offerings include customizable stories, books, movies, animations, songs, games, posters, and other customizable products and media. The customer selects an offering and is then prompted to input a wide range of information about the characters, including the number of characters and the preferred language for the text or audio. Previews are generated of all the characters, using a dynamic database of visual components associated with that offering. The customer may be given the option to directly modify the color, shape, and texture of visual components using a click and drag interface or other interface. Text, audio, and visuals for the offering are automatically generated according to the customer's selections. A low-resolution preview is presented to the customer for final verification. The finalized offering is then sold to the customer as a digital product or sent to a printer for production and fulfillment. The customer's selections are saved to expedite the customization of future offerings.

According to another embodiment of the invention, customized visuals are created using a two-dimensional method, in which two-dimensional visual components are turned on or of individually by adjusting the transparency of the corresponding layers. In this embodiment the two-dimensional visual components are created by an illustrator or animator ahead of time and turned on or off automatically with a script according the customer's selections.

According to another embodiment of the invention, customized visuals are created using a three-dimensional method, in which three-dimensional visual components are created and posed by an illustrator or animator ahead of time and turned on or off automatically with a script according to the customer's selections. A movie file is then produced incorporating those selections, or for static artwork a two-dimensional image is rendered from a predetermined viewpoint.

According to another embodiment of the invention, customized visuals are created using the combination method, in which both three-dimensional visual components and two-dimensional visual components are used in combination to create visuals for an offering.

According to another embodiment of the present invention, the customer may specify a pose for each character and object in addition to choosing the visual components, allowing for the user to create their own story, movie, or other product.

According to another embodiment of the invention, visual components are stored in a dynamic, structured database which organizes visual components by type for all available offerings. This allows said database to be easily expanded at any time, and has the technical advantage of allowing saved characters to instantly migrate from one offering to another.

According to another embodiment of the invention, the size of digital files is kept to a minimum by recursively adding categories of visual components to a base file.

It is to be understood that both the foregoing brief description of the invention and the following detailed description of the invention and preferred embodiments are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The various advantages and embodiments of the present invention will become apparent to one skilled in the art by reading the following specification and appended claims, and by referencing the following drawings, in which:

FIG. 1 is a block diagram of an example of the customization system, according to an embodiment of the invention.

FIG. 2A is a diagram of an example of an illustration customized using the Two-Dimensional Method 7 according to an embodiment of the invention.

FIG. 2B is a flowchart of an example of a method of incorporating multiple layers in the Two-Dimensional Method 7 according to an embodiment of the invention.

FIG. 3 is a diagram of an example of an illustration customized using the Three-Dimensional Method 8 according to an embodiment of the invention.

FIG. 4 is a diagram of an example of an illustration customized using the Combination Method 9 according to an embodiment of the invention.

FIG. 5 is an illustration of an example of a user interface according to an embodiment of the invention.

FIG. 6A is a flowchart of an example of a method of expanding the components database, according to an embodiment of the invention.

FIG. 6B is a diagram of an example of two different books created using the same user character data, according to an embodiment of the invention.

FIG. 7 is an illustration of examples of various important embodiments of the present invention, including custom e-books, custom interactive e-books, custom posters, custom clothing, custom door hangers, custom greeting cards, custom plates, custom mugs, custom placemats, custom stickers, custom animations, and custom interactive experiences.

### DETAILED DESCRIPTION OF THE INVENTION AND PREFERRED EMBODIMENTS

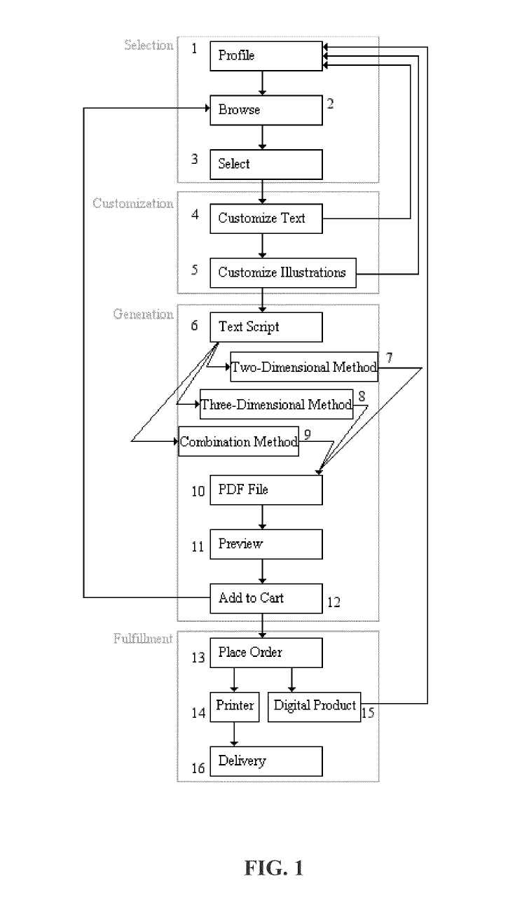

Referring now to the present invention in more detail, in FIG. 1 there is shown a block diagram of an example of the customization system, according to an embodiment of the invention. To access the customization system the user visits a website, installs a computer program, or downloads a cell phone application. The user creates a password-protected profile 1 to store their personal information and saved projects. Then the user proceeds to browse 2 available customizable stories, movies, products, and other customizable offerings searching based on criteria such as number of characters, keywords, and reading level. Next, the user selects 3 a story, product, or other offering to customize. The user customizes the text 4 of that story, product, or other offering by specifying information such as the number of characters, character names, character ages, the gender of characters, each character's relationship to the main character, the preferred language for the text if not English, names of pets, species of pets, favorite foods, hobbies, or other information. The user customizes the illustrations 5 by choosing background elements and customizing each character by selecting facial features, hair styles, clothes, and accessories for that character. User may choose colors for the skin, hair, eyes, clothes, and other visual elements, either from a list of colors or from a continuous spectrum of colors. In some embodiments, ages, heights, and other quantities specified by a user may also effect the physical appearance of the characters. Customized Text 4 and Customized Illustrations 5 are automatically saved in the user's Profile 1, and reused later when future stories, movies, products, or other offerings are customized by that same user, a process which is explained in greater detail in the discussion of FIG. 6B.

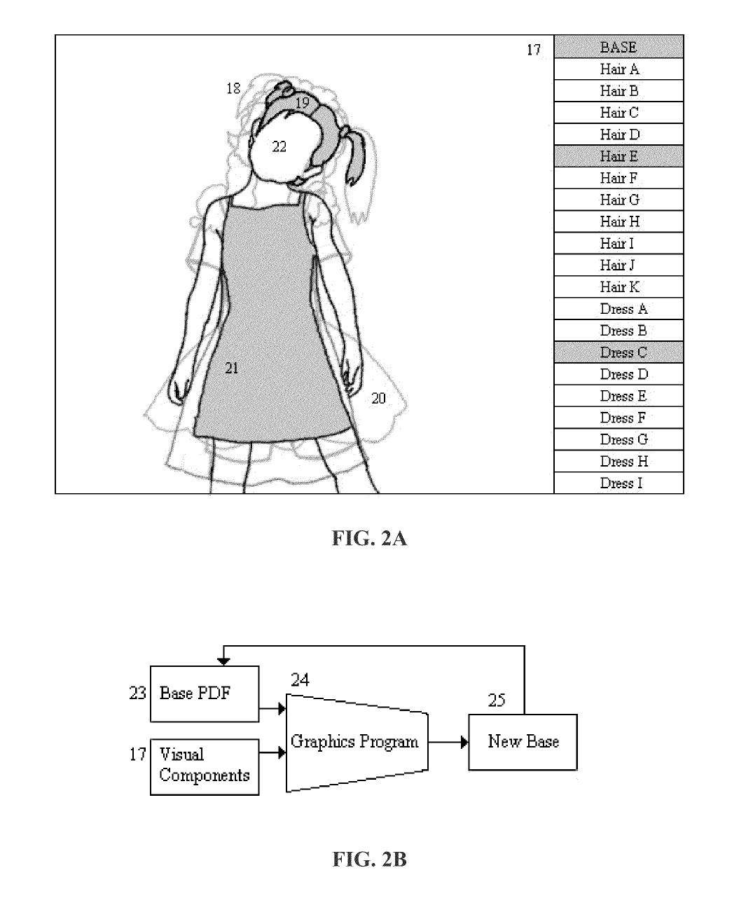

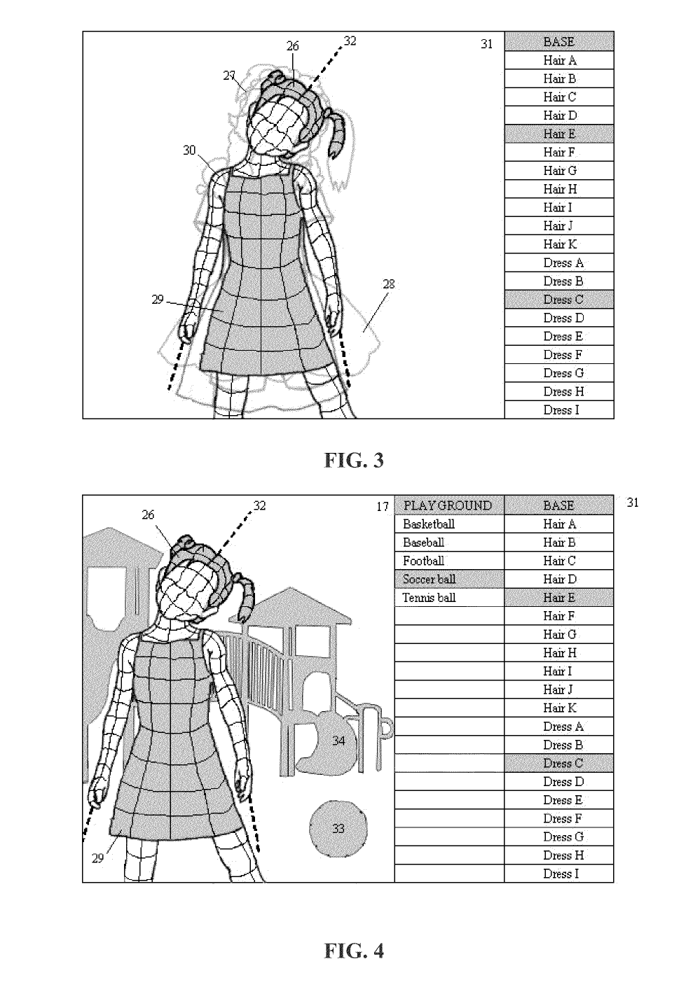

Still referring to the embodiment of the invention depicted in FIG. 1, the custom product, story or other offering is then generated by running a Text Script 6, which inserts the Customized Text 4 into the story, product, or other offering, adjusting the gender of pronouns appropriately, wrapping and fitting text according to an algorithm, and otherwise adjusting the text in a pre-defined way to reflect the selections of the user. For offerings with customizable audio such as movies and songs, audio may generated by combining pre-recorded fixed sound elements with pre-recorded variations of sound elements such as pre-recorded names, or a text-to-speech system may be employed for some or all of the audio, or the user may record their own voice for the audio, or some combination of the three. Next, the user's selections are used to generate Customized Illustrations 5 for the story, product, or other offering, using one of three methods: the Two-Dimensional Method 7, the Three-Dimensional Method 8, or the Combination Method 9. (These three embodiments of the invention are discussed in greater detail in the descriptions of FIG. 2A, FIG. 3, and FIG. 4 respectively.) These three methods, in conjunction with the Text Script 6, output a finished digital version of the story, product, or other offering typically as a PDF File 10 or other device-independent file format. A low resolution Preview 11 of the finished story, product, or other offering is presented to the user for final verification, and then the PDF File 10 or other digital version of the story is Added to the Cart 12 of the user. User may either return to Browse 2 additional stories and products, or Place an Order 13. Their story, product, or other offering may be purchased as either a Digital Product 15, for example an e-book, animation, etc. or as a printed product, for example a paperback or hardcover book, placemat, doorhanger, sheet of stickers, poster, mug, item of clothing, etc. For printed orders the PDF File 10 is sent to a Printer 14, and the printed product is then Delivered 16 to the user. Digital Products 15 are saved to the user's Profile 1, and made available for download any time after purchase.

Referring now to the present invention in even more detail, FIG. 2A shows a diagram of an example of an illustration customized using the Two-Dimensional Method 7 according to an embodiment of the invention. In the Two-Dimensional Method 7, Two-Dimensional Visual Components 17 are turned on or off individually by making the corresponding layer visible or invisible. In this embodiment the Two-Dimensional Visual Components 17 are created by an illustrator ahead of time and turned on or off automatically with a script according the user's selections. This selective transparency can be accomplished using any suitable multi-layer graphics program in which each layer can selectively obscure or reveal features of the layer beneath it via full opacity, full transparency, or varying levels of translucency, for example Adobe Photoshop, Adobe Illustrator, or The Gimp. In FIG. 2A an example user has made one Hair Component 19 (Hair E) and one Dress Component 21 (Dress C) visible over the Character Base 22. Shown as gray outlines are the Invisible Hair Components 18 and the Invisible Dress Components 20. Note that the example depicted in FIG. 2A has been greatly simplified for the sake of visual clarity. In more realistic embodiments of the present invention, all the Two-Dimensional Visual Components 17 would he commercial-quality artwork produced by an illustrator rather than silhouettes, and the list of Two-Dimensional Visual Components 17 would typically also include a broad range of eye components, mouth components, nose components, background components, clothing components, accessory components, and color and print options.

FIG. 2B shows a flowchart of an example of a method of incorporating multiple layers in the Two-Dimensional Method 7 according to an embodiment of the invention. Because the multiple layers of high-resolution Two-Dimensional Visual Components 17 typically result in very large files, computing power can be an issue. FIG. 2B shows how computing limitations can be avoided by adding categories of Two-Dimensional Visual Components 17 in series. The user's selection from a category of components, for example eye components, is saved on top of a Base PDF 23 using a Graphics Program 24. The resultant file, New Base 25, then serves as the Base PDF for the user's selection from the next category of components, for example mouth components. In this example, the base file and new base file are in PDF format, however many other file types may be substituted here, including other device-independent page description languages, various e-book formats, various movie formats, and the native formats of many graphics and animation editors. An analogous method can be employed for incorporating Three-Dimensional Visual Components 31.

FIG. 3 is a diagram of an example of an illustration customized using the Three-Dimensional Method 8 according to an embodiment of the present invention. In the Three-Dimensional Method 8, Three-Dimensional Visual Components 31 are turned on or off individually by making the component visible or invisible, or by adding or deleting components. In this embodiment the Three-Dimensional Visual Components 31 are created and posed by an illustrator ahead of time and turned on or off automatically with a script according the user's selections. A two-dimensional image is then rendered from a predetermined viewpoint. The illustrator can create the Three-Dimensional Visual Components 31 in any suitable three-dimensional graphics program, for example Maya.

In FIG. 3 an example user has added one Three-Dimensional Flair Component 26 (Hair E) and one Three-Dimensional Dress Component 29 (Dress C) to the Three-Dimensional Character Base 30. Shown as gray outlines are the Inactive Three-Dimensional Hair Components 27 and the Inactive Three-Dimensional Dress Components 28. Note that the example depicted in FIG. 3 has been greatly simplified for the sake of visual clarity. In more realistic embodiments of the present invention, the Three-Dimensional Character Base 30 and the Three-Dimensional Visual Components 31 would all be textured, commercial-quality 3D artwork produced by an illustrator, and the list of Three-Dimensional Visual Components 31 would typically also include a broad range of eye components, mouth components, nose components, background components, clothing components, accessory components, and other components.

A key difference between the Two-Dimensional Method 8 embodiment and Three-Dimensional Method 9 embodiment is that the Two-Dimensional Method 8 embodiment requires the illustrator to draw new Two-Dimensional Visual Components 17 for each illustration in the story or product. With the Three-Dimensional Method 9 embodiment, the illustrator builds each Three-Dimensional Visual Component 31 once, and then only needs to specify a Pose 32 for each character and each object to create each ensuing illustration. Another benefit of the Three-Dimensional Method 9 embodiment is that users can directly shape, texture, and color the Three-Dimensional Visual Components 31, granting the user even greater ability to customize their story or product. In another embodiment of the present invention the user may even create the Pose 32 for each character and object in addition to choosing the visual components, allowing for the user to write and illustrate their own story, product, or other offering.

FIG. 4 shows a diagram of an example of an illustration customized using the Combination. Method 9 according to an embodiment of the invention. In the Combination Method 8, both Three-Dimensional Visual Components 31 and Two-Dimensional Visual Components 17 are used to create an illustration or other visual for a story, product, or other offering. As with the Two-Dimensional Method 8 and Three-Dimensional Method 9 embodiments, all components can turned on or off individually with a script according the user's selections. In FIG. 4 an example user has added one Three-Dimensional Hair Component 26 and one Three-Dimensional Dress Component 29 to a Two-Dimensional Accessory Component 33 and a Two-Dimensional Background Component 34. As was the case for FIG. 2A and FIG. 3, the example depicted in FIG. 4 has been greatly simplified for the sake of visual clarity.

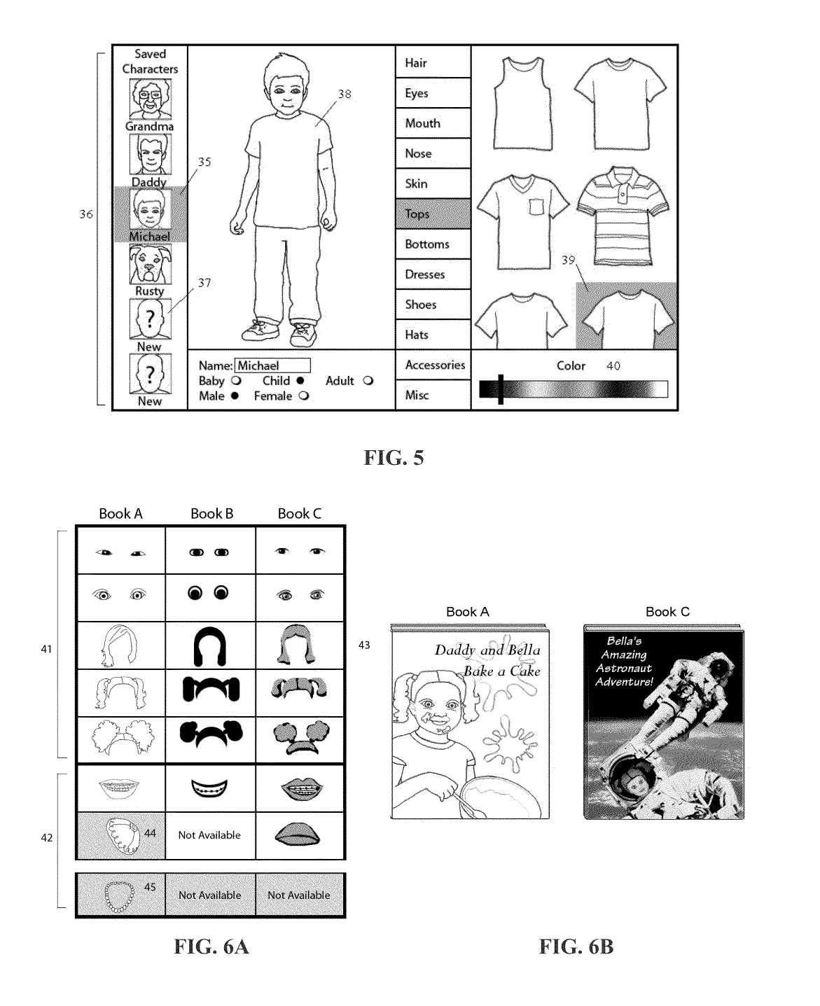

FIG. 5 is an illustration of an example of a user interface according to an embodiment of the invention. The user selects a Character to Edit 35 from a list of their Saved Characters 36, or they click an empty slot 37 to create a new character. A Preview 38 of the character is shown, updated continuously as each new Visual Component 39 is selected. Some of these visual components may be Two-Dimensional Visual Components 17 and some may be Three-Dimensional Visual Components 31. The user can Select Component Color 40, and for Three-Dimensional Visual Components 31 the shape and texture can also he directly adjusted. Changes made to the characters are carried through all illustrations or other visuals in the story, product, or other offering.

FIG. 6A is a flowchart of an example of a method of expanding the database of visual components, according to an embodiment of the invention. When each story, product, or other offering is created, the illustrator draws backgrounds and creates a set of Standard Visual Components 41. These Standard Visual Components 41 are common to all stories and products, but are drawn in different styles depending on the story, product, or other offering. For example, Medium Straight Hair 43 is a Standard Component 41 but is depicted in three different styles in each of the three books. in addition to Standard Visual Components 41, Supplementary Components 42 can also be created at any time. When a new Supplementary Component 42 is created, a check is performed to see if a similar component already exists for other stories, products, or other offerings. If it does exist, the new part is assigned the same name as the existing part and saved in the corresponding slot for the new story. (For example, when adding a Kippah 44 to Book. A, a check reveals this part already exists for Book C, so the new part is saved in the corresponding slot in Book A.) If it doesn't exist, the new part is assigned a new name, and an empty slot is created for all stories and products. (For example, when adding a Bead Necklace 45 to Book. A, a check reveals it does not exist for either book B or C, so a new slot is created in the Supplementary Component 42 database for all three books).

FIG. 6B is a diagram of an example of two different books created using the same user character data, according to an embodiment of the invention. When a character is created through the user interface, that character is saved to the user's profile as a set of visual components. As explained in the description of FIG. 6A, all Standard Visual Components 41 and many Supplementary Components 42 for a given offering have analog components in all other offerings. When future stories or other offerings are customized by the user, component analogs are used to create a default appearance for the characters in the new story or other offering. Here in FIG. 6B, the Standard Visual Components 41 pigtails and round eyes have been used to create the same girl in two different drawing styles for Book A and Book C.

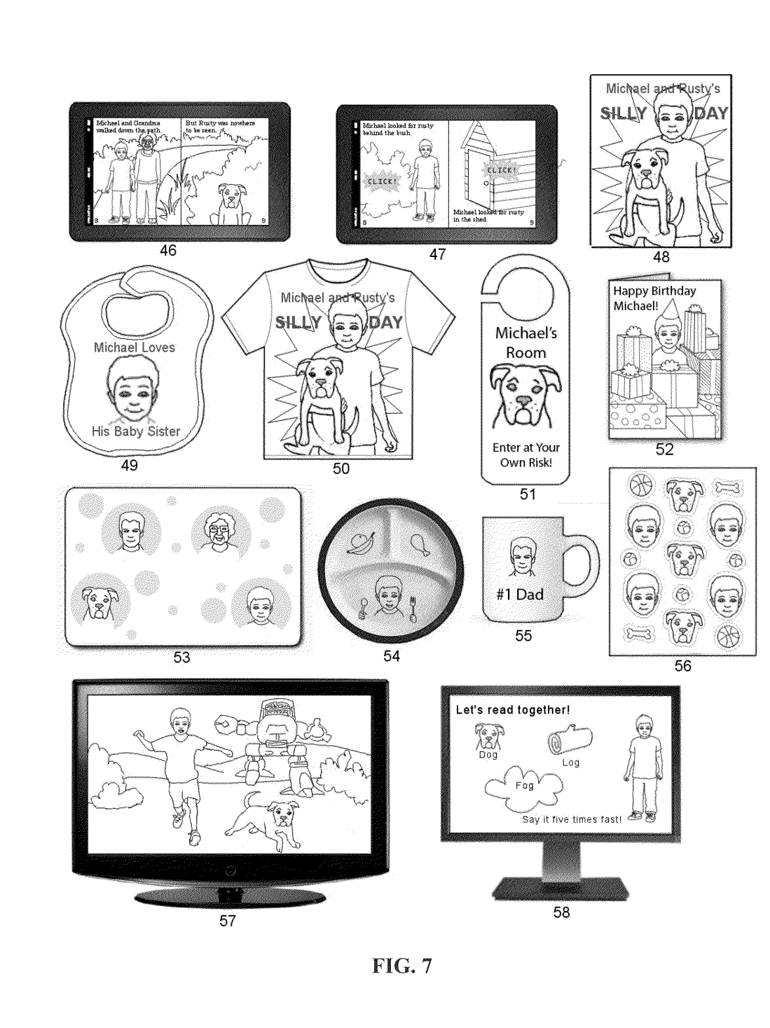

The most important embodiment of the present invention is highly customized paperback and hardcover picture books, which allow children to see themselves and their family starring in various adventures and stories. However, other significant embodiments exist, including books for older audiences, magazines, e-books, 3D books, interactive e-books, posters, clothing, doorhangers, placemats, utensils and dishware, cards, e-cards, stickers, animations, movies, episodic shows, interactive experiences, songs, keychains, magnets, notebooks, mousepads, decorated foods, and other products and media. These embodiments may either be a way of merchandizing an existing story, for instance custom pajamas that match the child's favorite custom book, or they may be sold as standalone products. FIG. 7 depicts examples of several such embodiments of the present invention, namely Custom E-books 46, Custom Interactive E-books 47, Custom Posters 48, Custom Bibs 49, Custom Shirts 50, Custom Door Hangers 51, Custom Greeting Cards 52, Custom Placemats 53, Custom Plates 54, Custom Cups 55, Custom Stickers 56, Custom Animations 57, and Custom Interactive Experiences 58.

Discussing FIG. 7 in even more detail, the first item depicted is an illustration of an example of a Custom E-book 46, according an important embodiment of the invention. With the present invention Custom E-books 46 are generated in the same manner as paper hooks, except instead of the PDF file 10 or other digital version of the story being sent to a Printer 14, it's formatted for use with various digital e-book readers. The second item depicted in FIG. 7 is an illustration of an example of a Custom Interactive E-hook 47, according to another embodiment of the invention. A Custom Interactive F-hook 47 is one that changes in response to a touch, click, or page turn, for instance by reading custom words aloud, playing custom animations, moving custom words or illustrations around, or offering custom games. The third item depicted in FIG. 7 is an illustration of an example of Custom Poster 48, according to another embodiment of the invention. The fourth item is an illustration of an example of a Custom Bib 49, according to an embodiment of the invention, and the fifth item is an illustration of an example of a Custom Shirt 50, according to an embodiment of the invention. The sixth item depicted in FIG. 7 is an illustration of an example of a Custom Door Hanger 51, according to an embodiment of the invention. The seventh item is an illustration of an example of a Custom Greeting Card 52, according to an important embodiment of the present invention. Custom greeting cards 52 may be printed on paper and mailed, or sent as custom digital e-cards. E-cards may be customized by the user in a similar fashion to custom books, and then may be delivered to the recipient (not necessarily to the user) as a link in the recipients email. E-cards may be static images, or have moving or interactive elements. The eighth item depicted in FIG. 7 is an illustration of an example of a Custom Placemat 53, according to an embodiment of the invention. The ninth item depicted in FIG. 7 is an illustration of an example of a Custom Plate 54, according to an embodiment of the invention, and the tenth item depicted in FIG. 7 is an illustration of an example of a Custom Cup 55, according to an embodiment of the invention. The eleventh item depicted in FIG. 7 is an illustration of an example of a sheet of Custom Stickers 56, according to an embodiment of the invention. The twelfth item depicted in FIG. 7 is an illustration of an example of a Custom Animation 57, according to another important embodiment of the invention. Custom Animations 57 are created using the Two-Dimensional Method 7, the Three-Dimensional Method 8, or the Combination Method 8, in conjunction either with hand-drawn animation methods or computer animation methods. The non-variable elements of the animation are created in the standard manner, and the custom elements of the animation are created by animating with base characters and then swapping in user-selected Two-Dimensional or Three-Dimensional Visual Components 17, 31 and rendering the animation, where swapping in may involve varying the transparency of, deleting, loading, or otherwise inserting user-selected Two-Dimensional or Three-Dimensional Visual Components 17, 31. Such animations may be released as a movie, an animated short, an episodic show starring the user and/or their family, or in some other form. The thirteenth item depicted in FIG. 7 is an illustration of an example of a Custom Interactive Experience 58, according to an embodiment of the invention. Here a custom character is shown acting as a guide or narrator for a website, but a Custom Interactive Experience 58 may be any product or story with interactive custom characters or drawings.

### Definitions

By “media publication” is meant: books, e-books, graphic books, 3D books, magazines, movies, short films, shows, episodic shows, episodic web shows, cartoons, cartoon books, greeting cards, beach towels, sheets, pillows, shirts, hats, pajamas, bibs, textiles, mugs, cups, glasses, plates, placemats, animations, e-cards, posters, art prints, mouse pads, stationery, notebooks, magnets, pins, keychains, pennants, stickers, doorknob hangers, playing cards, board games, songs, video/computer games, interactive media, on-line experiences, and the like. That is to say the instant invention applies to any article of commerce amenable to personalization by a user in a customizing process.

By “publish” is meant: make available in finalized form for binding, shipping, viewing, or downloading as the case may be.

I claim:

1. A system and method for publishing a customized media publication comprising:
a vendor-established digitized media publication having at least one of text, characters and illustrations disposed to be customized by a registered user;
said vendor providing an on-line accessible program permitting said user to perform said customization;
said user, having customized said digitized media publication, directs said vendor to publish and said media publication is published.

2. The system and method of claim 1 wherein said vendor-provided program presents vendor-selected features of an illustration of each character separately in selected variations in different layers in Photoshop or the like, said user selects a character, the program makes visible the corresponding layers and the user selects a variation of a feature which the program makes visible throughout the media publication all other layers being made invisible.

3. The system and method of claim 1 wherein said vendor creates at least one scene including a background and this and a tableau of at least one posed 3D character models are made available to the user and said user customizes the features of said at least one models and said customizations are propagated across all said at least one scenes.

4. The system and method of claim I wherein said vendor-provided program presents vendor-selected features of an illustration of each character separately in selected variations in one or more separate files, said user selects a character, the program loads the corresponding one or more files, and the user selects a variation of a feature which the program loads throughout the media publication all other layers being either deleted or never loaded.

5. The system and method of claim 1 wherein the vendor-provided program presents a posable 3D model for each character with specified poses and feature choices for each illustration in said media publication and said user selects poses and feature choices at will.

6. The system and method of claim 1 wherein the vendor-provided program presents a posable 3D model for each character and feature choices for each illustration in said media publication and said user creates poses for said model and selects feature choices at will.

7. The system and method of claim 3 wherein said feature choices include color, texture, size and shape.

8. The system and method of claim 3 wherein said user customizes said features by choosing from among vendor-selected variations of 3D features of each at least one 3D models.

9. The system and method of claim 3 wherein an interface allows said user to customize said features by directly manipulating at will the color, texture, size and shape of said features.

10. The system and method of claim 1 wherein the methods of claims 2 and 3 are combined in whole or in part.

11. The system and method of claim 2 wherein the color of said vendor-selected variations can be adjusted along a continuous color spectrum by said user.

12. A user interface for the system and method of claim 1 wherein said vendor provides a website, program or application wherein said user can design and save one or more avatars of family or friends adjusting such features as facial characteristics, hair color and style, clothing, accessories and the like, said user selecting a vendor-provided media publication and inserting said one or more avatars into that media publication, said vendor then printing said media publication.

13. A database structure for the system and method of claim 2, wherein comparable vendor-selected variations are identified across all vendor-established media publications, vendor-selected variations without direct analog in a given vendor-established media publication are assigned a closest match for said media publication, new instances of vendor-selected variations can be added to the database at any time, and based on the combination of variations of features selected by a user for one media publication, a combination of feature variations can be suggested to the user for all other vendor-established media publications.

14. A database structure for the system and method of claim 3, wherein comparable feature customizations are identified across all vendor-established media publications, feature customizations without direct analog in a given vendor-established media publication are assigned a closest match for said media publication, new instances of feature customizations can be added to the database at any time, and based on the combination of feature customizations selected by a user for one media publication, a combinations of feature customizations can be suggested to the user for all other vendor-established media publications.

15. The system and method of claim I wherein said vendor generates a movie, animation, or other moving image, customizes said movie, animation, or other moving image according to the selections of said user, and said vendor-provided program publishes said movie, animation, or other moving image.

16. The system and method of claim 15 wherein said movie, animation, or other moving image is generated using 2D animation techniques or graphics programs, and customized through the addition, removal, or varied transparency of vendor-selected 2D features, according to the selections of said user.

17. The system and method of claim 15 wherein said movie, animation, or other moving image is generated using 3D animation techniques or graphics programs, and customized through the addition, removal, or varied transparency of vendor-selected 3D features according to the selections of said user, or through the direct manipulation at will by said user of the the color, texture, size and shape of said 3D features, or through some combination of the two.

18. The system and method of claim 1 wherein, in the course of publishing said media publication, said vendor adds, flattens, loads, renders, processes or otherwise combines customizable elements in more than one batch.

19. The system and method of claim 1 wherein the number of characters in said media publication can be changed according to the selections of said user.
